(19) United States
(12) Patent Application Publication
(10) Pub. No.: US 2020/0324353 A1
(43) Pub. Date: Oct. 15, 2020

(54) CIRCULAR SAW

(71) Applicant: The M.K. Morse Company, Canton, OH (US)

(72) Inventor: Chandra Sekhar Rakurty, Canton, OH (US)

(21) Appl. No.: 16/847,203

(22) Filed: Apr. 13, 2020

Related U.S. Application Data
(60) Provisional application No. 62/833,186, filed on Apr. 12, 2019.

(51) Int. Cl. B23D 61/02; B23D 61/04

(52) U.S. Cl. CPC B23D 61/021; B23D 61/04

(57) ABSTRACT

A circular saw includes a generally circular base plate having a central point about which the base plate may rotate. The base plate has a peripheral edge about the circumference of the base plate. The peripheral edge defines a plurality of alternating tip seats and gullets, where the radial depth of the gullets may be less than the radial height of the tip seats. A plurality of tips are each disposed at a respective tip seat. The plurality of tips includes a first group of tips having at least one groove on a top face, and a second group of tips having at least one groove on a top face, where the groove of the first group is off set from the grove of the second group.

### CROSS-REFERENCE TO RELATED APPLICATIONS

This application claims priority to and the benefit of U.S. Provisional Patent Application No. 62/833,186, filed 12 Apr. 2019, the contents of which are hereby incorporated by reference in their entirety.

### BACKGROUND

This relates in general to cutting tools. One type of know cutting tool is the circular saw. A known circular saw is shown in FIGS. 1-4. The circular saw includes a generally circular base plate 120 having a central point 122 about which the base plate 120 may rotate. An arbor hole 123, for cooperation with a mounting on a power unit for rotating the circular saw, is formed about the central point 122. The base plate 120 also has a peripheral edge 124 about the circumference of the base plate 120. The peripheral edge 124 defines a plurality of alternating tip seats 126 and gullets 128. As best shown in FIG. 4, as will be further described below, a plurality of virtually identical tips 130 is each disposed at a respective tip seat 126.

As best shown in FIG. 2, the tip seats 126 have a radial height H1, measured from the edge of the gullet 128 to the top of the tip seat 126, and the gullets 128 have a radial depth D1, measured from the edge of the tip seat 126 to a bottom point P1 of the gullet 128. The depth D1 of the gullet 128 is greater than the height H1 of the tip seat 126. The circumferential length L1 of the gullet 128 from the edge of the tip seat 126 to the bottom point P1 of the gullet 128 is greater than the depth D1 of the gullet 128 and also greater than the height H1 of the tip seat 126.

As best shown in FIGS. 3 and 4, each of the tips 130 has a flat planar top face 132. Each tip 130 has a flat planar back face 134 and a flat planar bottom face 136 to be disposed in tip seat 126. The tip 130 has a front face 138 that includes a cutting edge 140 and a cutting face 142. The cutting edge 140 and the cutting face 142 extend from the top face 132 more than half the height of the front face 138, with the cutting face 142 alone being more than half the height of the front face 138. The cutting face 142 is formed as an arcuate or curved face in the front face 138.

### SUMMARY

This relates more particularly to an improved circular saw with improved tips and gullets.

According to at least one embodiment, a circular saw includes a generally circular base plate having a central point about which the base plate may rotate. The base plate also has a peripheral edge about the circumference of the base plate. The peripheral edge defines a plurality of alternating tip seats and gullets. A plurality of tips is each disposed at a respective tip seat. The plurality of tips includes a first group of tips having at least one groove on a top face and a second group of tips having at least one groove on a top face. The groove of the first group is off set from the grove of the second group.

In at least one embodiment, the radial depth of the gullets is less than the radial height of the tip seats.

In at least one embodiment, the tips of the first group and the second group include a front face having a cutting edge and a cutting face. The cutting edge and the cutting face may extend from the top face less than half the height of the front face.

In at least one embodiment, the cutting face of the tips includes a substantially planar portion.

In at least one embodiment, the gullets extend circumferentially between tips seats with a bottom point radially closest to the central point. The circumferential distance from one tip set to the bottom point is less than the depth of the gullet.

In at least one embodiment, the tips of the first group and the tips of the second group each include at least two grooves on the top face. The grooves of the first group may be off set from the grooves of the second group.

In at least one embodiment, the plurality of tips includes a third group of tips including at least one groove on a top face. The groove of the third group may be off set from the grooves of the first and second groups. The tips of the first group and the tips of the second group and the tips of the third group may each include at least two grooves on the top face. The grooves of the first group, the grooves of the second group, and the grooves of the third group may all be off set from one another.

Along the peripheral edge, each tip of the third group may be preceded by tip of the second group, and/or each tip of the second group may be preceded by a tip of the first group.

Tips of the first group, the second group, and the third group may include a front face having a cutting edge and a cutting face, with the cutting edge and the cutting face extending from the top face less than half the height of the front face

The cutting face of the tips may include a substantially planar portion.

Various aspects will become apparent to those skilled in the art from the following detailed description and the accompanying drawings.

### BRIEF DESCRIPTION OF THE DRAWINGS

FIG. 1 is a side view of a known base pate for a circular saw.

FIG. 2 is an enlarged view of a portion of FIG. 1.

FIG. 3 is a side view of a known tip for use with the base plate of FIG. 1.

FIG. 4 is a partial perspective view of the combination of the tip of FIG. 3 and the base plate of FIG. 1.

FIG. 5 is a side view of a base pate for a circular saw in accordance with an embodiment of the present invention.

FIG. 6 is an enlarged view of a portion of FIG. 5.

FIG. 7 is a side view of a tip in accordance with an embodiment of the present invention for use with the base plate of FIG. 5.

FIG. 8 is a partial perspective view of the combination of the tip of FIG. 7 and the base plate of FIG. 5.

FIG. 9 is a back perspective view of a set of tips in accordance with an embodiment of the present invention.

FIG. 10 is a schematic representation of a cut pattern in a work piece made with a circular saw with the tip set of FIG. 9.

FIG. 11 is a front side perspective view of a tip of another set of tips of a circular saw in accordance with an embodiment of the present invention.

FIG. 12 is a front perspective view of the tip of FIG. 11 shown cutting into a work piece.

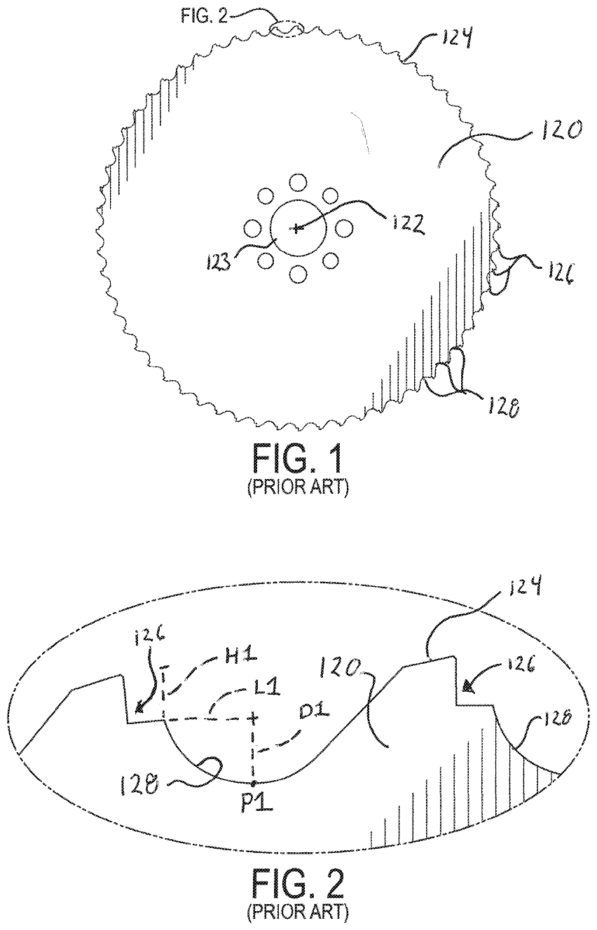

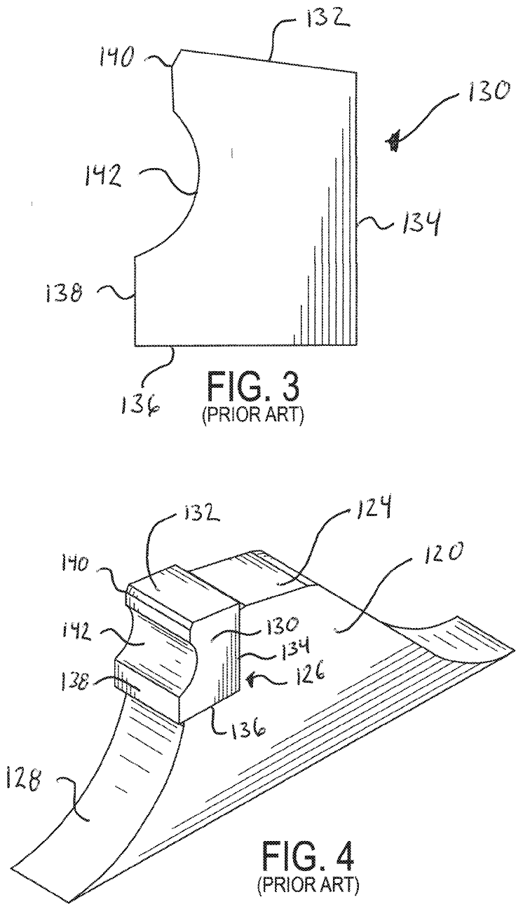

### DETAILED DESCRIPTION

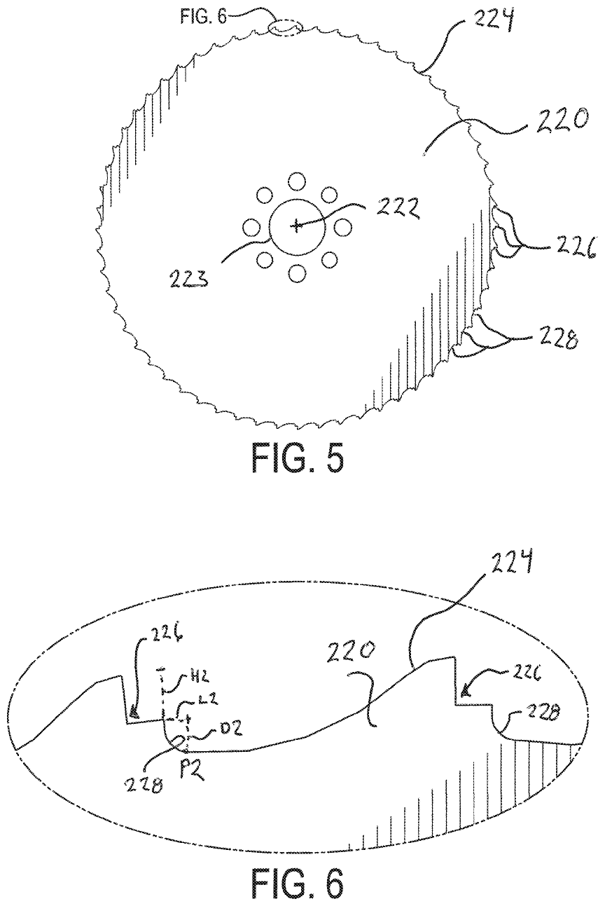

Referring now to the drawings, there is illustrated in FIGS. 5-8 a circular saw in accordance with an embodiment of the present invention. As shown in FIGS. 5 and 6, the circular saw includes a generally circular base plate 220 having a central point 222 about which the base plate 220 may rotate. An arbor hole 223, for cooperation with a mounting on a power unit for rotating the circular saw, is formed about the central point 222. The base plate 220 also has a peripheral edge 224 about the circumference of the base plate 220. The peripheral edge 224 defines a plurality of alternating tip seats 226 and gullets 228.

As best shown in FIG. 6, the tip seats 226 have a radial height H2, measured from the edge of the gullet 128 to the top of the tip seat 226, and the gullets 228 have a radial depth D2, measured from the edge of the tip seat 226 to a bottom point P2 of the gullet 228. The depth D2 of the gullet 228 is less than the height H2 of the tip seat 226. The circumferential length L2 of the gullet 228 from the edge of the tip seat 226 to the bottom point P1 of the gullet 228 is less than the depth D2 of the gullet 228 and also less than the height H2 of the tip seat 226.

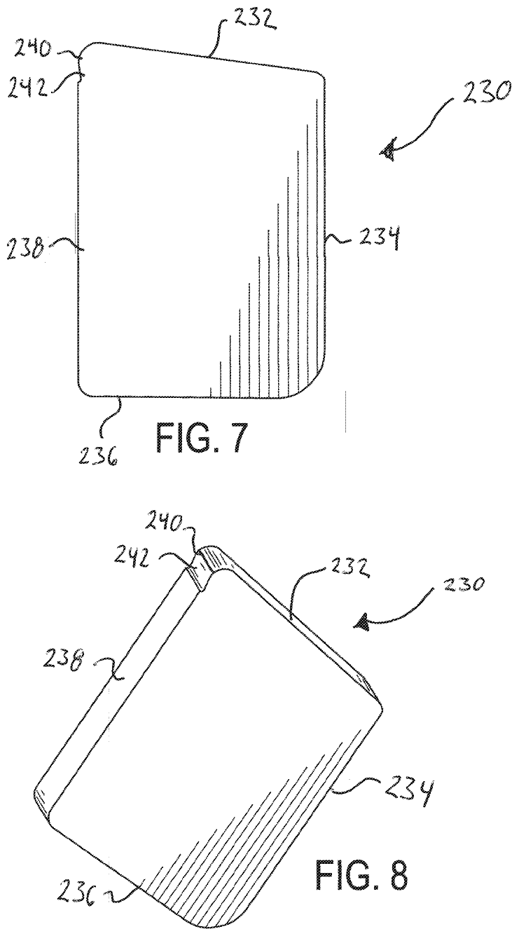

As shown in FIGS. 7 and 8, a tip 230, that may disposed at a respective tip seat 226, has a generally flat planar top face 232. The tip 230 has a flat planar back face 234 and a flat planar bottom face 236 to be disposed in tip seat 226. The tip 230 has a front face 238 that includes a cutting edge 240 and a cutting face 242. As shown, the edges between the top face 232, the back face 234, the bottom face 236, and the front face 238 have been optionally beveled. Alternatively, these edges may optionally be chamfered.

The cutting edge 240 and the cutting face 242 extend from the top face 232 less than 1/7th of the height of the front face 238. In a number of exemplary embodiments, the cutting edge 240 and the cutting face 242, extend less than ⅙th, ⅕th, ¼th, ⅓rd, and one-half of the height of the front face 238. The cutting face 242 includes a substantially planar portion between the cutting edge 240 and the remainder of the front face 238. It is believed that such geometry results in chip break closer to the cutting edge as compare to other geometries, and is believed to be generally preferred.

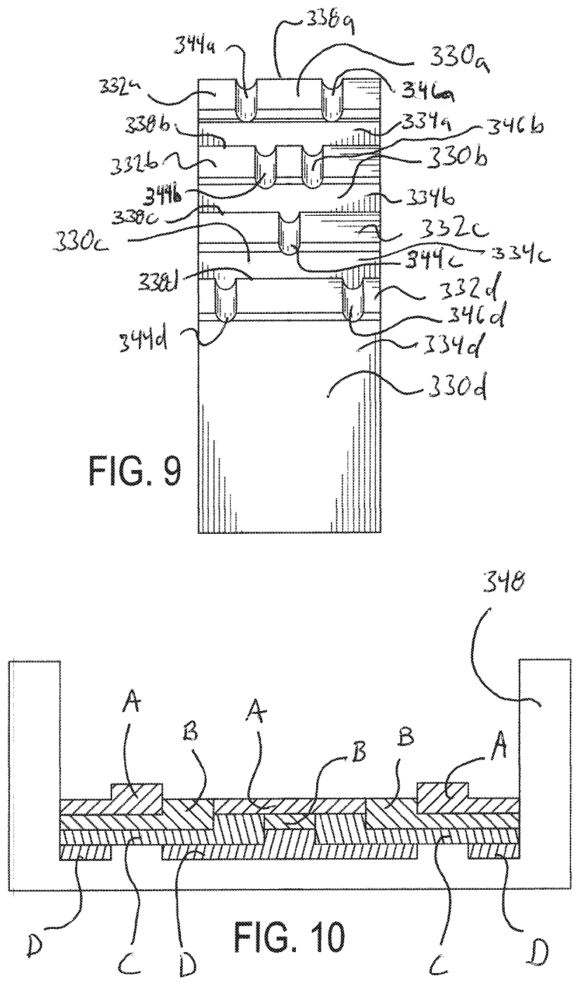

Referring now to FIG. 9, in an exemplary embodiment, a circular saw may have a plurality of tips including a plurality of groups, including, for example, a first group of first tips 330a, a second group of second tips 330b, a third group of third tips 330c, and a fourth group of fourth tips 330d. The tips 330a, 330b, 330c, and 330d each include a first groove 344a, 344b, 344c, and 344d on a respective top face 332a, 332, b, 332c, and 332d, extending between a respective front face 338a, 338b, 338c, and 338d, and a respective back face 334a, 334b, 334c, and 334d. In this exemplary embodiment, the tips 330a, 330b, and 330d also each include a second groove 346a, 346b, and 346d on the respective top face 332a, 332, b, and 332d, extending between the respective front face 338a, 338b, and 338d, and the respective back face 334a, 334b, and 334d. In the exemplary embodiment, the first and second grooves 344a, 344b, 344c, and 344d and 346a, 346b, and 346d all extend perpendicularly to their respective front faces front faces 338a, 338b, 338c, and 338d, and their respective back faces 334a, 334b, 334c, and 334d although such is not required. Further, in the exemplary embodiment, the first and second grooves 344a, 344b, 344c, and 344d and 346a, 346b, and 346d all extend parallel to one another, although such is not required, It is further noted that a variety of alternative embodiments are contemplated in which the plurality of tips may include and any number of groups of tips two or more.

As shown in FIG. 9, the first and second grooves 344a, 344b, 344c, and 344d and 346a, 346b, and 346d are all preferably off set from one another such that a passing of the tips in operation of the circular saw would not result in the first or second groove 344a, 344b, 344c, or 344d or 346a, 346b, 346d of one group of tips overlapping with the first or second groove 344a, 344b, 344c, or 344d or 346a, 346b, or 346d. Such an, operation on a workpiece 348 is illustrated in FIG. 10 with the material removed by the first tip 330a is represented by sections A, the material removed by the second tip 330b is represented by sections B, the material removed by the third tip 330c is represented by sections C, and the material removed by the fourth tip 330d is represented by sections D.

It is noted that it is contemplated that a circular saw in accordance with several embodiments may include groups of tips with one, two, three or more grooves, or any combination there of.

In at least one embodiment, the plurality of tips forms a pattern where each fourth tip 330d is preceded by a 330c, and/or each third tip 330c is preceded by a second tip 330b and/or each second tip 330b is preceded by a first tip 330a, and/or each first tip 330a is preceded by a fourth tip 330d.

It is noted that in the present exemplary embodiment, the selected geometry of tips results in formation of generally symmetric chips from the workpiece, which is believed to be preferable.

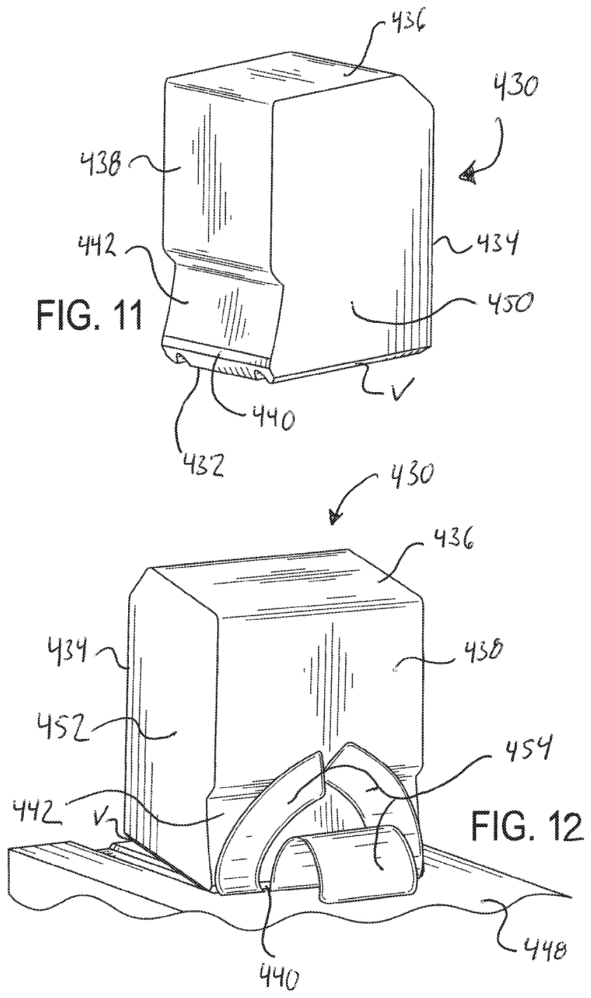

Referring now to FIGS. 11 and 12, there is another embodiment of a tip 430 shown cutting a workpiece 448. The tip 430 includes a bottom face 436 and a back face 434, with a chamber therebetween, to be disposed in a tip seat, such as the tip seat 226 described above. The tip 430 has a front face 438 that includes a cutting edge 440 and a cutting face 442. The tip 430 has a generally flat planar top face 432, and as shown, the edges between the top face 432, and side faces 450 and 452 have been optionally beveled, as indicated at V. The cutting edge 440 and the cutting face 442 extend from the top face 432 less than one-half of the height of the front face 238. The cutting face 242 includes a substantially planar portion between the cutting edge 240 and the remainder of the front face 238. The top face 432 includes first and second parallel grooves 444 and 446 extending perpendicularly from the front face 438 to the back face 434. Operation of the tip 430 created generally symmetric chips 454 from workpiece 448.

It is noted that in at least one embodiment the tips are preferably fixed to the tip seats by brazing, although any suitable mechanism may be used.

While principles and modes of operation have been explained and illustrated with regard to particular embodiments, it must be understood, however, that this may be practiced otherwise than as specifically explained and illustrated without departing from its spirit or scope.

What is claimed is:

1. A circular saw comprising:
a generally circular base plate having a central point about which the base plate may rotate, and having a peripheral edge about the circumference of the base plate, the peripheral edge defining a plurality of alternating tip seats and gullets, where the radial depth of the gullets is less than the radial height of the tip seats, and
a plurality of tips each disposed at a respective tip seat, the plurality of tips including a first group of tips including at least one groove on a top face and a second group of tips including at least one groove on a top face, where the groove of the first group is off set from the grove of the second group.

2. The circular saw of claim 1 where the tips of the first group and the second group include a front face having a cutting edge and a cutting face, where the cutting edge and the cutting face extend from the top face less than half the height of the front face.

3. The circular saw of claim 1 where the cutting face of the tips include a substantially planar portion.

4. The circular saw of claim 1 where the gullets extend circumferentially between tips seats with a bottom point radially closest to the central point, where the circumferential distance from one tip set to the bottom point is less than the depth of the gullet.

5. The circular saw of claim 1 where the tips of the first group and the tips of the second group each include at least two grooves on the top face, where the grooves of the first group are off set from the grooves of the second group.

5. The circular saw of claim 1 where the plurality of tips include a third group of tips including at least one groove on a top face, where the groove of the third group is off set from the grooves of the first and second groups.

7. The circular saw of claim 6 where the tips of the first group and the tips of the second group and the tips of the third group each include at least two grooves on the top face, where the grooves of the first group, the grooves of the second group, and the grooves of the third group are all off set from one another.

8. The circular saw of claim 7 where, about the peripheral edge, each tip of the third group is preceded by tip of the second group.

9. The circular saw of claim 8 where, about the peripheral edge, each tip of the second group is preceded by a tip of the first group.

10. The circular saw of claim 6 where the tips of the first group, the second group, and the third group include a front face having a cutting edge and a cutting face, where the cutting edge and the cutting face extend from the top face less than half the height of the front face, and where the cutting face of the tips include a substantially planar portion.

11. A circular saw comprising:
a generally circular base plate having a central point about which the base plate may rotate, and having a peripheral edge about the circumference of the base plate, the peripheral edge defining a plurality of alternating tip seats and gullets, and
a plurality of tips each disposed at a respective tip seat, the plurality of tips including a first group of tips including at least one groove on a top face and a second group of tips including at least one groove on a top face, where the groove of the first group is off set from the grove of the second group.

12. The circular saw of claim 11 where the tips of the first group and the second group include a front face having a cutting edge and a cutting face, where the cutting edge and the cutting face extend from the top face less than half the height of the front face.

13. The circular saw of claim 11 where the cutting face of the tips include a substantially planar portion.

14. The circular saw of claim 11 where the gullets extend circumferentially between tips seats with a bottom point radially closest to the central point, where the circumferential distance from one tip set to the bottom point is less than the depth of the gullet.

15. The circular saw of claim 11 where the tips of the first group and the tips of the second group each include at least two grooves on the top face, where the grooves of the first group are off set from the grooves of the second group.

16. The circular saw of claim 11 where the plurality of tips include a third group of tips including at least one groove on a top face, where the groove of the third group is off set from the grooves of the first and second groups.

17. The circular saw of claim 16 where the tips of the first group and the tips of the second group and the tips of the third group each include at least two grooves on the top face, where the grooves of the first group, the grooves of the second group, and the grooves of the third group are all off set from one another.

18. The circular saw of claim 17 where, about the peripheral edge, each tip of the third group is preceded by tip of the second group.

19. The circular saw of claim 18 where, about the peripheral edge, each tip of the second group is preceded by a tip of the first group.

20. The circular saw of claim 16 where the tips of the first group, the second group, and the third group include a front face having a cutting edge and a cutting face, where the cutting edge and the cutting face extend from the top face less than half the height of the front face, and where the cutting face of the tips include a substantially planar portion.
